(19) United States
(12) Patent Application Publication
(10) Pub. No.: US 2026/0276142 A1
(43) Pub. Date: Sep. 17, 2026

(54) UNIVERSAL FLEXIBLE CLAMP

(71) Applicant: Flexible OR Solutions LLC, Dripping Springs, TX (US)

(72) Inventor: Tommy Lee Hodsden, Dripping Springs, TX (US)

(21) Appl. No.: 19/440,987

(22) Filed: Jan. 6, 2026

Related U.S. Application Data
(60) Provisional application No. 63/771,870, filed on Mar. 14, 2025.

(51) Int. Cl. F16M 13/02

(52) U.S. Cl. CPC F16M 13/027

(57) ABSTRACT

A clamp for adjustable mounting to a ceiling and receiving a structural framing member having a base plate with multiple base plate slots and two side plates extending from the base plate with rows of slots disposed on a first side plate for fastening the framing member, wherein the distance between the side plate corresponds to the width of the structural framing member.

### PRIORITY

The present invention claims priority to U.S. 63/771,870 filed Mar. 14, 2025, the entirety of which is hereby incorporated by reference.

### TECHNICAL FIELD

This disclosure relates to universal clamps for use in the commercial or residential construction process, and in particular to a structural framing members for mounting on steel beams, concrete joists and concrete slab ceilings of a structure.

The presently described universal clamp is used in the construction process. As part of the process, structural framing members, such as structural framing members, beams and the like, are part of the construction process. As used herein, the term “structural framing member” includes but is not limited to beams, girders and the like. Often structural framing members are installed at an upper level of a building, near the ceiling, to support other structures or suspended items. One setting where structural framing members are installed is in a hospital or outpatient medical facility. Note, however, that this is but one setting and the description of the hospital or surgical setting is by no means limiting, as the described universal claim is used in limitless settings. The hospital or outpatient surgical setting serves as a convenient example of one of the clamp's many uses.

In the hospital or surgical facility setting, structural framing members are employed if one wishes to improve, relocate or add surgical room equipment that is ceiling mounted or interfaces with equipment located above the ceiling in the operating room. In operating room construction, a support structure may be integrated above the ceiling is configured to support operating room ceiling systems and ceiling mounted medical equipment (anesthesia booms, surgical lights, etc.) via modular steel rails, such as Hilti brand structural framing members or rails. An issue is encountered, however, in terms of mounting the structural framing members to the pre-existing ceiling of the room. Ideally, the installer of the structural framing members will encounter a uniform situation in terms of the mounting substrate for the structural framing members. In reality, however, there may be rooms or areas within a room where the structural framing members are to be mounted on a flat concrete slab of a ceiling at one place, on an I-beam in another place, and on a joist, often a concrete joist, in yet another.

This inconsistency is compounded by the various sources and configurations of the structural framing members themselves. Structural framing members are made by the various manufacturers in various lengths, widths and depths. Placement of slots or holes on the various structural framing members, however, is not standard. For example, some structural framing member holes are recessed and spaced more closely together than others. Precision mounting of structural framing members is essential for many construction projects without forcing or damaging the structural framing member because of a less-than-uniform mounting situation. What is needed, therefore, is a universal and flexible clamp that is mountable on a variety of substrates and can accommodate structural framing members of different designs.

### SUMMARY

According to the present disclosure, a universal and flexible clamp for mounting a structural framing member is described. In one embodiment, the clamp includes a u-shaped body comprising a channel area formed by a base plate and a first side plate extending perpendicularly from the base plate and a second side plate extending perpendicularly from the plate. The base plate and the first side plate and the second side plate form the channel having dimensions for receipt of standard, commercially available structural framing members. The interface of the base plate and the first and second side plate form a first flange and a second flange, each flange containing flange slots through which fastening devices, such as bolts, are inserted. The flanges also provide enhanced stability when flush mounting the clamp to a ceiling or connecting to an I-beam. The flanges also serve as a connection means for an accompanying L-bracket for mounting on a joist made of concrete or other material.

The first side plate and second side plate each include a plurality of slots into which fasteners are inserted to secure a structural framing member having a plurality of holes. The plurality of slots on each of the side plates are arranged in rows. In one embodiment, several slots are arranged at a proximate end of each side plate (in close proximity to the interface between each side plate and the base plate). Addition slots are arranged at the distal end of each side plate in offset rows.

An accompanying L-bracket comprises a vertical flange and a horizontal flange, the vertical flange having a length greater than the horizontal flange's depth. The L-bracket is fastened flush to a joist by inserting fasteners through some or all of a plurality of vertical flange holes arranged to provide secure fastening of L-bracket to the joist. A horizontal flange includes one or more horizontal flange slots that align with the flange slots disposed within the first flange and second flange of the base plate. The elongation of the flange slots and the horizontal flange slots allow for adjustment when connecting the universal clamp to the L-bracket when the L-bracket is used for joist installation and the base slot lengths accommodate installation on joists or beams of different widths.

### BRIEF DESCRIPTION OF THE DRAWINGS

The present invention is illustrated by way of example and is not limited by the accompanying figures, in which like references indicate similar elements. Elements in the figures are illustrated for simplicity and clarity and have not necessarily been drawn to scale.

FIG. 1 depicts prior art structural framing members that are mounted with an embodiment of the present disclosure;

FIG. 2 depicts top and side views of universal claim components according to an embodiment;

FIG. 3 is a plan view of a universal flexible clamp installed on a joist according to an embodiment;

FIG. 4 is a plan view of a universal flexible clamp mounted on a flat ceiling according to an embodiment;

FIG. 5 is a plan view of a universal flexible clamp installed on an I-beam according to an embodiment.

### DETAILED DESCRIPTION

In the following detailed description of exemplary embodiments of the invention, specific exemplary embodiments in which the invention may be practiced are described in sufficient detail to enable those skilled in the art to practice the invention, and it is to be understood that other embodiments may be utilized and that architectural, mechanical, electrical and other changes may be made without departing from the spirit or scope of the present invention. The following detailed description is, therefore, not to be taken in a limiting sense, and the scope of the present invention is defined only by the appended claims and their equivalents.

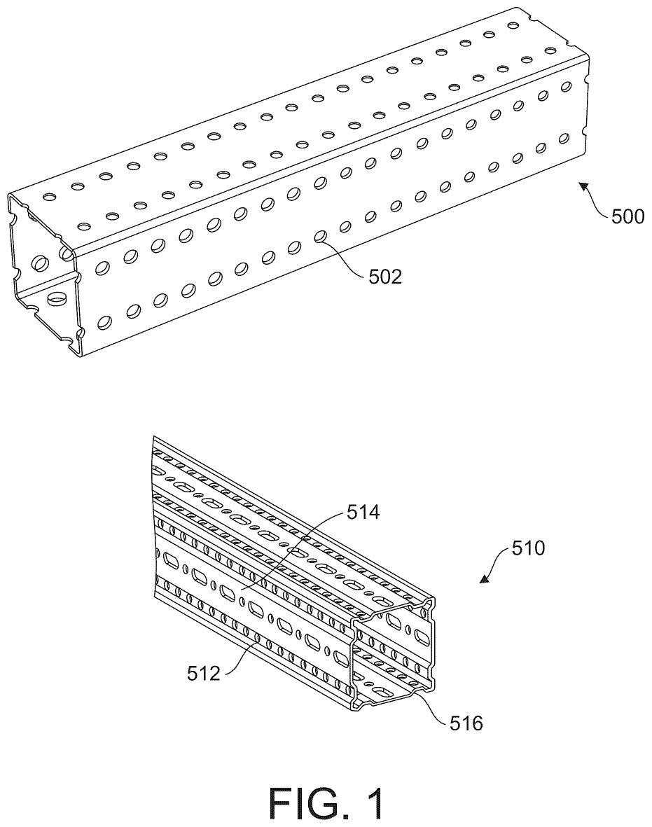

FIG. 1 depicts structural framing members that are installed using the presently described universal clamp. FIG. 1 shows the varying styles and features of some commercially available structural framing members. It is noted that the size and type of structural framing member shown and described is only exemplary. The form, function and application of the presently described universal flexible clamp is applicable to structural framing members of varying sizes. That is, the overall dimensions of the described universal flexible clamp can vary to accommodate structural framing members such as beams, girders and the like while offering the same flexibility and functionality as described herein. One example is Hilti's MT-90 structural framing member 500 which includes rows of holes 502 arranged at uniform intervals along the length of the structural framing member. Another is Sikla's siFramo F100 structural framing member 510. The siFramo F100 structural framing member 510 also has rows of holes 512 arranged uniformly but also includes alternate slots and holes 514 along the length of the structural framing member. The siFramo F100 structural framing member 510 also includes recessed regions 516 on each face of structural framing member 510 in which rows of holes 512 sit. There are other structural framing member designs, but structural framing members universally include rows of holes and/or slots that allow for flexibility and numerous mounting locations when installing the structural framing members and equipment thereon. Note that depiction and discussion of structural framing members 500 and 510 are by no means limiting and do not limit the size and functionality of the presently described universal clamp. The universal clamp described herein in just one embodiment having dimensions to accommodate structural framing members having properties like structural framing members 500 and 510. The presently described universal clamp can be sized to accommodate structural framing members of any size.

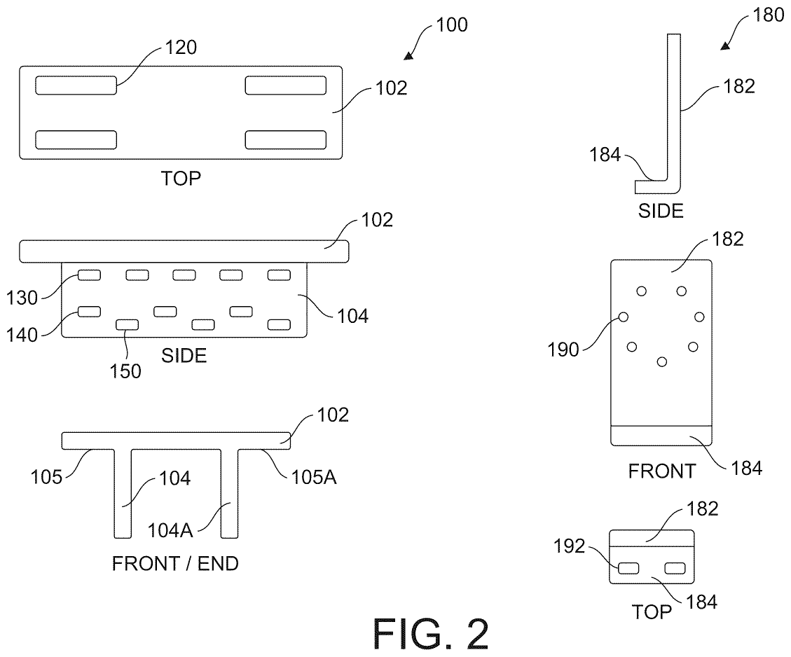

FIG. 2 provides top, side and front/end views of the presently described universal clamp and accompanying L-bracket. In FIG. 2, universal clamp 100 comprises a base plate 102 that includes a plurality of base plate slots 120. As shown, four base plate slots 120 are disposed at the corners of base plate 102 in one embodiment, but more slots may be present for larger universal clamps. Base plate 102 serves as the interface between a ceiling or I-beam on which it is mounted. In joist applications, base plate 102 is coupled to L-bracket 180, as will be discussed.

Continuing, front/end view of universal clamp 100 depicts a first side plate 104 extending perpendicularly from base plate 102 and a second side plate 104A extending perpendicularly from base plate 102. First side plate 104 and second side plate 104A are spaced from each other at a distance that corresponds to the width of the structural framing member product that the user intends to install. First flange 105 and second flange 105A are formed by the portions of base plate 102 that extend outward from first side plate 104 and second side plate 104A, respectively. As seen in the front view of universal clamp 100, the arrangement of base plate 102 and first side plate 104 and second side plate 104A form a channel in which a structural framing member is placed and secured.

Side view of universal clamp 100, and in particular of first side plate 104 and second side plate 104A are shown. First side plate 104 includes rows of slots for installing a structural framing member. First side plate 104 comprises top row slots 130 that in one embodiment are evenly spaced along the length of first side plate 104. Middle row slots 140 of first side plate 104 are disposed in one embodiment below the vertical midpoint of first side plate 104. Bottom row slots 150 are disposed beneath middle row slots 140 and above the lower edge of first side plate 104. Individual middle row slots 140 and bottom row slots 150 are evenly spaced horizontally from each other in their respective rows, but middle row slots 140 are offset horizontally in relation to bottom row slots 150 in order to provide increased flexibility in terms of accommodating structural framing members having various hole patterns. This is a facet of the universal nature of the presently described invention. The same arrangement of rows of slots that are disposed on first side plate 104 is disposed on second side plate 104. That is, in one embodiment both first side plate 104 and second side plate 104A include the same arrangement of three rows of slots as described in relation to first side plate 104.

FIG. 2 also depicts top, front and side views of L-bracket 180. L-bracket comprises a vertical flange 182 and a horizontal flange 184, joined to form a perpendicular L shaped bracket as shown in the side view. In an embodiment, L-bracket is of a single body construction. Front view of L-bracket 180 shows the front view of horizontal flange 182. As shown, horizontal flange 182 includes a plurality of L-bracket holes 190 spaced in an approximate circle, although the exact placement of L-bracket holes 190 may vary. The spacing of L-bracket holes 190 provide the user flexibility when mounting the L-bracket on a joist, which is the contemplated use. Top view of L-bracket 180 depicts L-bracket slots 192 disposed on horizontal flange 182 of the L-brackets. L-bracket slots 192 are elongated to provide adjustability when attaching base plate 102 of universal clamp 100 for joist installation, as will be described.

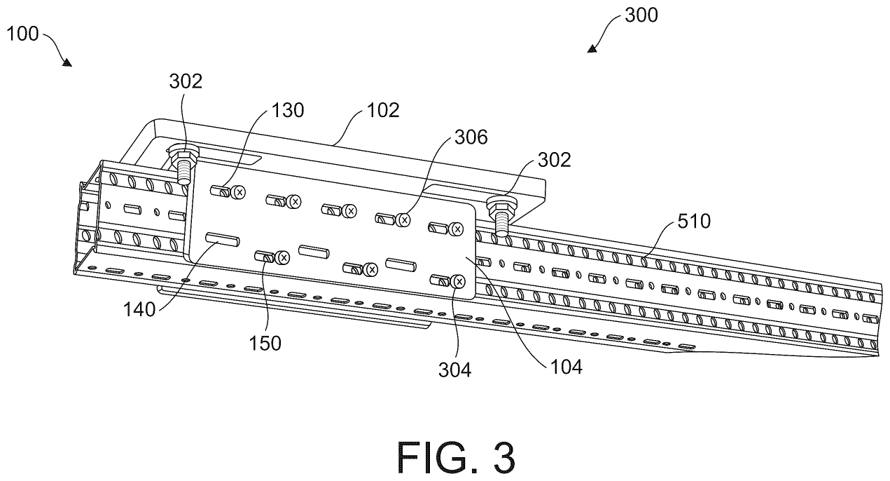

Universal clamp 100 as installed is shown in FIGS. 3, 4 and 5. In FIG. 3, universal clamp 100 is flush mounted to ceiling 300. Base plate 102 of universal clamp 100 is mounted directly on ceiling 300 and secured by anchor bolts and nut combinations 302 that pass through corresponding base plate slots 120. The elongated base plate slots 120 provide flexibility in aligning anchor bolts with the slots for securing base plate 102 to ceiling 300. As shown, structural framing member 510 is inserted into the channel formed by base plate 102, first side plate 104 and second side plate 104A (not visible). Fasteners 306 are inserted through top row slots 130 to secure structural framing member 510 within clamp 100. Fasteners 306 include but are not limited to rivets or other suitable fastening items as known in the art. Similarly, fasteners 304 are inserted through bottom row slots 150 to further secure structural framing member 510. In this depiction, middle row slots are not employed because of placement of the holes within structural framing member 510 do not require their use. In other applications, middle row slots will be used.

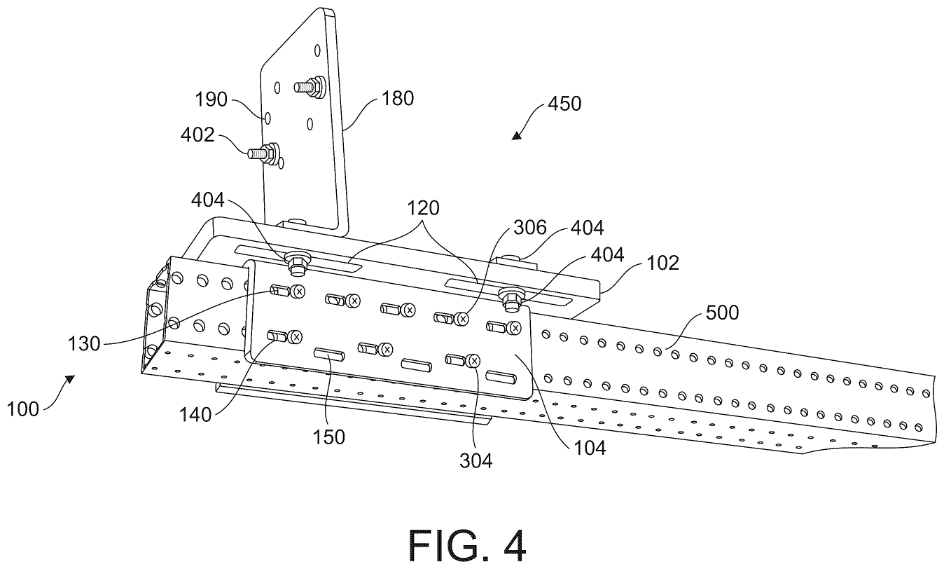

FIG. 4 depicts use of universal clamp 100 and accompanying L-bracket 180 to install the clamp on a joist, such as a concrete joist. In the installation of FIG. 4, structural framing member 500 is installed in the channel of clamp 100, which has different hole spacing than structural framing member 510 of FIG. 3. In FIG. 4, therefore middle row slots 140 are employed and fasteners 304 are inserted through middle row slots 140 of the first side plate 104 and second side plate 104A (not visible) to secure structural framing member 500 within the channel. Bottom row slots 150 are not used.

To install clamp 100 to a joist, base plate 102 is attached to horizontal flange 184 of L-bracket 180, with L-clamp 180 fixed to the side of joist 450. Anchor bolts (embedded in joist 450) and nuts 402 secure L-bracket 180 to joist 450 by passing through some or all of L-bracket holes 190 to mount vertical flange 182 flush against joist 450. Universal clamp 100 is attached to L-bracket 180 by inserting bolts 404 through L-bracket slots 192 of horizontal flange 184 and base plate slots 120 of base plate 102. Nuts secure bolts 404 to tightly secure base plate 102 against the underside of vertical flange 182 of L-bracket 180. The elongated configuration of base plate slots 120 accommodate joists 450 of varying thickness. A second L-bracket 180 (not visible) is secured to the back face of joist 450 in a similar manner and is fastened to corresponding base plate slots 120 of base plate 102. Thus, L-brackets are fastened to both sides of joist 450 and are then secured to base plate 102, providing a flexible and secure clamp for receipt of a structural framing member at a desired location.

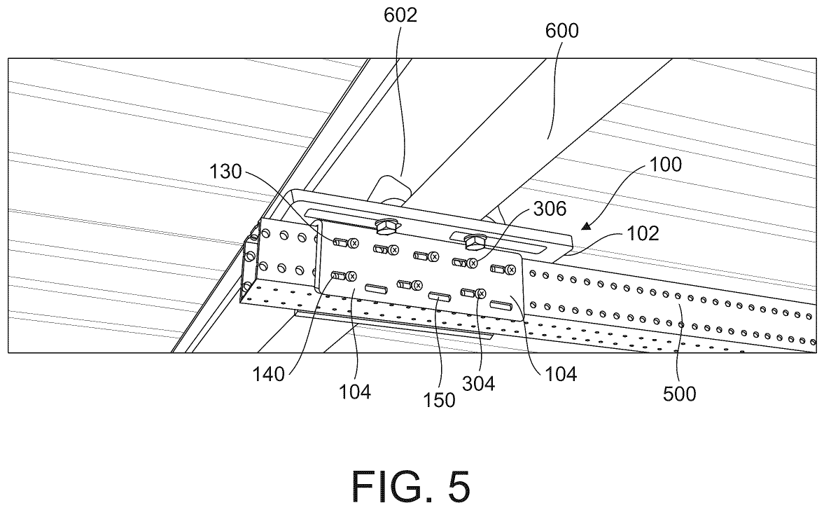

FIG. 5 depicts installation of an embodiment of universal clamp 100 on I-beam 600. Structural framing member 500 is installed within the channel region of clamp 100 in the manner described in connection with FIG. 4 and will not be repeated. In FIG. 5, universal clamp 100 is secured to a steel beam, such as an I-beam by securing beam clamp 602 to base plate 102. In this application, beam clamp 602 includes bolts that pass through base plate slots 102 and the beam clamp 602. The bolts are secured at the top of beam clamp 602 by bolts. The elongated structure of base plate slots accommodates varying widths of I-beam surfaces against which base plate 102 of universal clamp 100 is installed.

As shown in the accompanying figures and described, the configuration of the base plate and side plates of the clamp provide a flexible and universal connector for installing structural framing members from different manufacturers having different mounting hole patterns onto surfaces or structures of various sizes and shapes, such as ceilings, joists and steel beams.

Although the invention is described herein with reference to specific embodiments, various modifications and changes can be made without departing from the scope of the present invention as set forth in the claims below. Accordingly, the specification and figures are to be regarded in an illustrative rather than a restrictive sense, and all such modifications are intended to be included within the scope of the present invention. Any benefits, advantages, or solutions to problems that are described herein with regard to specific embodiments are not intended to be construed as a critical, required, or essential feature or element of any or all the claims.

What is claimed:

1. A clamp, comprising:
a base plate having a plurality of base plate slots;
a first side plate extending perpendicularly from the base plate;
a second side plate extending perpendicularly from base plate;
a first flange formed by a portion of the base plate extending outward from the first side plate;
a second flange formed by a portion of the base plate extending outward from the second side plate;
a first row of slots disposed along an upper edge of the first side plate;
a second row of slots disposed below the first row of slots;
a third row of slots disposed below the second row of slots;
a plurality of base plate slots disposed on the base plate;
wherein the first side plate and second side plate are a distance from each other corresponding to a width of a structural framing member product installed on the clamp.

2. The clamp of claim 1, further comprising:
an L-shaped bracket comprising a vertical flange and a horizontal flange;
a plurality of L-shaped bracket holes spaced in an approximate circle and disposed on the vertical flange; and
an L-shaped bracket slot disposed on the horizontal flange;
wherein the L-shaped bracket slot is elongated for flexible alignment with two of the plurality of base plate slots.

3. The clamp of claim 1, wherein the first row of slots is evenly spaced along the length of the upper edge of the first side plate.

4. The claim of claim 1, wherein the second row of slots are disposed below the vertical midpoint of the first side plate.

5. The clamp of claim 1, wherein the second row of slots are even spaced horizontally on the first side plate.

6. The clamp of claim 1, wherein the third row of slots are even spaced horizontally on the first side plate.

7. The clamp of claim 1, wherein the second row of slots are offset horizontally in relation to the third row of slots.

8. The clamp of claim 1, wherein the base plate is mountable directly on a ceiling.

9. The clamp of claim 2, wherein the L-shaped bracket is mountable on a ceiling joist and is adjustably connectable to the base plate.

10. The clamp of claim 1, further comprising a fourth row of slots disposed along an upper edge of the second side plate;
a fifth row of slots disposed below the fourth row of slots; and
a sixth row of slots disposed below the fifth row of slots.

11. A clamp system, comprising:
a base plate having a plurality of base plate slots;
a first side plate extending perpendicularly from the base plate;
a second side plate extending perpendicularly from base plate;
a first row of slots disposed along an upper edge of the first side plate;
a second row of slots disposed below the first row of slots;
a third row of slots disposed below the second row of slots;
a first base plate slot disposed on a first flange formed by a portion of the base plate extending outward from the first side plate;
a second base plate slot disposed on a second flange formed by a portion of the base plate extending outward from the second side plate; and
an L-shaped bracket comprising a vertical flange and a horizontal flange adjustably connected to an upper side of the base plate, wherein the L-shaped bracket is mountable on a ceiling joist and is adjustably connectable to the base plate.

12. The clamp system of claim 11, wherein the first side plate and second side plate are a distance from each other corresponding to a width of a structural framing member product installed on the clamp.

13. The clamp of claim 11, further comprising a plurality of L-shaped bracket holes spaced in an approximate circle and disposed on the vertical flange.

14. The clamp system of claim 13, further comprising an L-shaped bracket slot disposed on the horizontal flange, wherein the L-shaped bracket slot is elongated for flexible alignment with two of the plurality of base plate slots.

15. The clamp system of claim 11, wherein the first row of slots is evenly spaced along the length of the upper edge of the first side plate.

16. The clamp system of claim 15, wherein the second row of slots are disposed below the vertical midpoint of the first side plate.

17. The clamp system of claim 16, wherein the second row of slots are even spaced horizontally on the first side plate.

18. The clamp system of claim 16, wherein the third row of slots are even spaced horizontally on the first side plate.

19. The clamp system of claim 17, wherein the second row of slots are offset horizontally in relation to the third row of slots.

20. The clamp system of claim 11, further comprising a fourth row of slots disposed along an upper edge of the second side plate;
a fifth row of slots disposed below the fourth row of slots; and
a sixth row of slots disposed below the fifth row of slots.
